(19) United States
(12) Patent Application Publication
(10) Pub. No.: US 2026/0158555 A1
(43) Pub. Date: Jun. 11, 2026

(54) FILTER SYSTEM HAVING INDIVIDUALLY SEPARABLE FILTER CHAMBERS

(71) Applicant: EOS GMBH ELECTRO OPTICAL SYSTEMS, Krailling (DE)

(72) Inventors: Tobias EBERHORN, München (DE); Ulrich KLEINHANS, Prittriching (DE); Jörn REHSÖFT, München (DE); Philip STRÖBEL, Weidenbach (DE)

(21) Appl. No.: 18/861,196

(22) PCT Filed: Apr. 27, 2023
(86) PCT No.: PCT/EP2023/061142

§ 371 Date: Oct. 28, 2024

(30) Foreign Application Priority Data
Apr. 29, 2022 (DE) 10 2022 204 255.7

(51) Int. Cl. B22F 10/28; B22F 10/32; B22F 12/70; B22F 12/90; B33Y 10/00; B33Y 30/00

(52) U.S. Cl. CPC B22F 10/28; B22F 10/32; B22F 12/70; B22F 12/90; B33Y 10/00; B33Y 30/00

(57) ABSTRACT

Disclosed is a device for providing a process gas atmosphere during a manufacturing process of a three-dimensional object. The device includes a gas circulation system having a gas circuit that is closed during operation, a filter system having a plurality of filter chambers that is arranged in the closed gas circuit, and at least three filter chambers for filtering particles in the gas circuit. The device also includes a gas control device that separates a number of filter chambers from the gas circuit during the ongoing manufacturing process and that can ensure that a number of filter chambers remaining in the gas circuit exceeds the number of filter chambers separated from the gas circuit.

The present invention relates to an apparatus and a method for providing a process gas atmosphere during an additive manufacturing process, and to an additive manufacturing process adapted thereto and an additive manufacturing apparatus adapted thereto.

Apparatuses and methods for an additive manufacture of three-dimensional objects are used, for example, in methods that are referred to as “rapid prototyping”, “rapid tooling” and “additive manufacturing”. An example of such a method is known under the name “selective laser sintering” or “selective laser melting”. Here, a layer of a building material that usually is in powder form is applied repeatedly and the building material in each layer is selectively solidified by selective irradiation of positions in this layer that correspond to the cross section of the object to be manufactured with a laser beam, for example in that the building material at these positions is partially or completely melted by means of the energy provided by the laser beam and subsequently the melt solidifies during cooling. Further details are described, for example, in EP 2 978 589B1 .

During an additive manufacturing process, a process gas atmosphere is often maintained in a process chamber in which the building material is selectively treated by means of radiation. The process gas atmosphere is usually an inert gas atmosphere (also referred to as “protective gas atmosphere”) since some building materials, in particular when they contain metal, tend to oxidize at the high temperatures that occur, which would prevent the formation of objects or at least would prevent the formation of objects having a material structure as desired. For example, titanium could start to burn in an uncontrolled manner in the presence of oxygen.

During the manufacturing process, a portion of the building material is frequently evaporated as a result of the irradiation, which leads to the formation of condensates after the vapors that have formed have resolidified. Furthermore, a portion of the building material is frequently whirled up. In addition, the irradiation can result in the formation of spatters. In general, these are solidified drops of the melt of the building material having a diameter between, for example, 20 and 300 μm. For example, by a piercing of the laser beam, spatters are thrown out of the melt that forms and the melt pool, respectively.

The mentioned effects during the irradiation of the building material also lead to contaminants in the process gas atmosphere, which can have an adverse effect on the additive manufacturing process, in particular can reduce the quality of the manufactured objects. For example, a laser beam that scans the building material can be absorbed, scattered or deflected by contaminants contained in the process gas atmosphere. Furthermore, contaminants can also be deposited on a coupling window for the laser beam or can be deposited on the surface of a building material layer. In order to meet high quality and efficiency requirements for the manufacturing process, such contaminants must therefore be removed from the process chamber as quickly as possible, for which purpose usually a gas flow is generated in the process chamber.

For a low consumption of resources, the process gas, e.g. argon, is circulated. However, this makes it necessary to clean the process gas from the contaminants by filtering before it is returned to the process chamber. For this purpose, a filter device with a suitable filter element is arranged in the process gas circuit. Since the filter elements used become more and more contaminated in the course of operation, they must be changed or replaced at certain time intervals. For this purpose, the process gas circuit is interrupted and the filter element is removed. After the insertion of a new filter element, the process gas circuit is put again into operation.

In order to further reduce the consumption of resources, DE 10 2014 207 160 A1 proposes to carry out a cyclic cleaning of a filter element by means of a gas pressure surge in order to extend the change interval of the filter element.

EP 3 321 071 A1 deals with the problem that the operation of an additive manufacturing apparatus must be interrupted when the filter element is changed, since an additive manufacturing process can only be carried out when a filtering of the process gas flow takes place. To solve the problem, a switching device is proposed, by means of which it is possible to individually switch a plurality of filter modules into an operating state, in which the process gas can flow through them, and into a non-operating state, in which the process gas cannot flow through them. Thereby, it can be ensured that an operation of the additive manufacturing apparatus does not have to be interrupted during the change of a filter element.

The inventors have found that offsets and discolorations can in the manufactured objects, which impair the quality, can result from cleaning and changing processes of filter elements.

It is therefore an object of the invention to provide an apparatus and a method, by means of which the quality of the manufactured objects can be improved.

The object is achieved by an apparatus and a method for providing a process gas atmosphere according to claims 1 and 14, and by an additive manufacturing apparatus and an additive manufacturing method according to claims 13 and 20. Further developments of the invention are respectively specified in the dependent claims. Here, the methods can also be developed further by the features of the apparatuses specified in the description or in the dependent apparatus claims. Likewise, the apparatuses can also be developed further by the features of the methods specified in the description or in the dependent method claims.

An inventive device for providing a process gas atmosphere during a manufacturing process of a three-dimensional object in a process chamber of an additive manufacturing apparatus, wherein the object is manufactured by applying a build material layer by layer and by solidifying the build material by supplying radiation energy to solidification positions in each layer, which solidification positions are assigned to the cross section of the object in this layer, which comprises a gas circulation system with a gas circuit that is closed during operation for a process gas conveyed through the process chamber, wherein a filter system with a plurality of filter chambers is arranged in the closed gas circuit, is characterized in that at least three filter chambers exist, each of which has at least one filter element for filtering particles in the gas circuit, and in that there exists a gas control device for controlling the gas circuit, which gas control device is set up such that it can separate a number of filter chambers from the gas circuit during the ongoing manufacturing process and can ensure that a number of filter chambers remaining in the gas circuit at least temporarily, preferably all the time, exceeds the number of filter chambers separated from the gas circuit.

Additive manufacturing apparatuses to which the invention relates are here in particular those that are suitable for the generative manufacture of three-dimensional objects, in particular from a metal-containing build material. In particular, this relates to such manufacturing apparatuses in which the objects are built up layer by layer, such as laser melting and laser sintering apparatuses. For supplying the radiation energy, it is possible to use e.g. one or more gas or solid-state lasers or any other type of lasers, for example also laser diodes, in particular VCSELs (Vertical Cavity Surface Emitting Laser) or VECSELs (Vertical External Cavity Surface Emitting Laser), or a line of these lasers. Instead of a laser, it is possible to use e.g. another light source, an electron beam or any other energy or radiation source that is suitable for solidifying the build material.

In addition, however, an application in generative apparatuses that do not operate layer by layer and that operate at a high process temperature in order to melt build material having a high melting point, for example laser cladding apparatuses, is also possible. In all of the aforementioned cases, instead of using an apparatus with a laser, it is also possible to use an apparatus in which an electron beam is used for introducing the necessary energy for melting the build material.

Preferably, metal-containing build materials are used, for example iron-and/or titanium-containing build materials, but also copper-, magnesium-, aluminum-, tungsten-, cobalt-, chromium- and/or nickel-containing materials. The aforementioned elements can be present on the one hand almost in pure form (making up more than 80 percent by weight of the build material) or else as a constituent of alloys.

A process chamber is considered to be a region of the manufacturing apparatus in which the additive manufacturing process takes place and which is enclosed by an enclosure, so that a gas atmosphere different from that in the surrounding of the manufacturing apparatus can be maintained in its interior. The process gas in the interior of the process chamber may in particular be an inert gas such as nitrogen, helium or argon, wherein the process gas may also contain mixtures of different chemical elements and the pressure in the process chamber can optionally also be below the atmospheric pressure. It is in particular also conceivable that the process gas also has further constituents in addition to inert gases.

The gas circulation system has a gas conveying device, e.g. a high-pressure fan or centrifugal fan, and a gas pipe system by means of which the gas can be guided through the process chamber in a closed circuit, so that a gas flow can be provided in the process chamber during a manufacturing process.

When the gas circulation system is operated, the gas conveying device provides for a continuous process gas stream in which process gas that has been conveyed through the process chamber is supplied to a filter system and is supplied to the process chamber again by the filter system, so that a closed gas circuit is formed. The filter system contains at least one filter chamber through which the process gas flow is conveyed. In the following, the side of the filter chamber at which the process gas flow enters the filter chamber is also referred to as raw gas side. In the following, the side of the filter chamber at which the process gas flow leaves the filter chamber again after passing through a filter element is also referred to as clean gas side.

At least one filter element is located in each filter chamber, which means that two or more filter elements can also be present in a filter chamber, at which filter elements a maintenance can be carried out after the filter chamber has been separated from the gas circuit.

The gas control device may contain a CPU, the operation of which is controlled by a computer program (software). The computer program may be stored on a storage medium, from which it can be loaded into the gas control device. Alternatively, it is also possible to implement the gas control device in the form of a control program, which is executed by a control unit serving to control the additive manufacturing process in an additive manufacturing apparatus. A prerequisite for this is that the corresponding control unit is connected by means of connecting lines or wirelessly to the hardware components, by means of which filter chambers can be separated from the gas circuit. A wireless connection can be implemented by means of radio, WLAN, NFC, Bluetooth or the like, in that the control unit has corresponding receivers and transmitters.

For example, by means of a control unit contained in the gas control device it can be ensured that a number of filter chambers remaining in the gas circuit exceeds the number of filter chambers separated from the gas circuit. It has been found that as a result of such provision, the quality of the manufactured objects can be improved. A preliminary explanation for this is the following:

For a high quality of the manufactured objects, it is necessary for a manufacturing process that it proceeds preferably without interruptions and that in addition the process gas flow is subject to fluctuations as small as possible during the ongoing manufacturing process. In other words, the volume flow (rate) in the gas circuit should be as constant as possible. When a plurality of filter chambers are arranged parallel to one another in a closed gas circuit, each filter chamber contributes, as a result of the filter(s) arranged therein, to an overall flow resistance that results from the parallel connection of the flow resistances of the individual filter chambers. When individual filter chambers are separated from the gas circuit, the overall flow resistance changes abruptly. Particularly for large volume flow rates, the ability of the gas conveying device to adapt the conveying capacity to the changed overall flow resistance is limited. Accordingly, fluctuations of the volume flow through the process chamber will occur and, as a result thereof, discontinuities or structural heterogeneities that occur in the manufactured objects will result.

A high volume flow (rate) is usually accompanied by a high velocity of the process gas flowing through the process chamber. Here, due to the inventive approach, it is guaranteed that the process gas velocity remains substantially constant, i.e. at best fluctuates within a small interval. Thus, a constant removal of contaminants (spatters, smoke, etc.) that are formed during the manufacturing process is provided for, if one proceeds in the inventive manner during a manufacturing process in the process chamber of the additive manufacturing apparatus. However, for example when no manufacturing process takes place in the process chamber, but, in order to avoid contaminating the process chamber from outside, a process gas flow is nevertheless maintained in the process chamber, albeit at a reduced process gas velocity, it is possible to refrain from ensuring that a number of filter chambers remaining in the gas circuit exceeds the number of filter chambers separated from the gas circuit.

By ensuring that a number of filter chambers remaining in the gas circuit exceeds the number of filter chambers separated from the gas circuit, the fluctuations in the volume flow when filter chambers are separated can be limited and thus a high quality of the manufactured objects can be ensured. In particular, this applies to high volume flows, which are advantageous insofar as the filter area can be increased, whereby the maintenance intervals of the filter elements (e.g. a cleaning or a replacement of filter elements) are extended.

A provision that a number of filter chambers remaining in the gas circuit exceeds the number of filter chambers separated from the gas circuit can be implemented e.g. such that before a filter chamber is separated from the process gas flow it is checked whether, as a result of such separation, the number of filter chambers remaining in the gas circuit no longer exceeds the number of filter chambers separated from the gas circuit, and the separation is only carried out if this is not the case. In other words, by the gas control device it is prevented that a maximum number of filter chambers decoupled from the process gas flow at a point in time is exceeded. In particular, the value of this maximum number can be stored in a memory and, if the total number Ntotal of the filter chambers connectable to the process chamber is changed, can be adapted.

It should also be noted that in this application, with respect to the invention, often a cleaning or a replacement of filter elements is mentioned, but that the present invention is not restricted thereto. Rather, it leads to advantages in all cases, in which —for whatever reason—filter chambers shall be separated from the gas circuit or shall be additionally integrated into the same.

In a preferred embodiment, at least five filter chambers, each with at least one filter element therein, are present and the device is configured to simultaneously separate a plurality of filter chambers from the gas circuit for a maintenance process (e.g. a cleaning or a replacement of filter elements). Thereby, a maintenance can be carried out in a more efficient manner, since filter elements can be cleaned or replaced in parallel.

In a special embodiment, each of the filter chambers has at least one filter element for filtering particles in the gas circuit, which filter element can be cleaned by a gas pressure surge and/or can be replaced.

Over time, a filter covering made of a layer of compacted and/or adhering particles, which is generally referred to as “filter cake”, will form on the filter elements. This filter cake impedes the gas flow and leads to a steadily increasing pressure drop at the filter. The most frequent maintenance process at a filter chamber is therefore a reduction of the pressure drop at a filter chamber. Usually, this is effected by cleaning a filter element by means of a gas pressure surge. Additionally or alternatively, the filter element with the deposits can be removed from the filter chamber and can be replaced by another filter element without deposits. For this purpose, the filter chamber usually has to be opened, so that constituents of the ambient atmosphere can enter the open filter chamber and can reach the filter element to be replaced. The filter element itself preferably has no enclosure for preventing the access of ambient air to the filter element during a replacement of the filter element.

In a special embodiment, the plurality of filter chambers has a substantially equal volume and/or the filter elements have a substantially equal filter area and/or an equal filter medium and/or the supply pipes and discharge pipes respectively connected to the plurality of filter chambers have a substantially equal area of the opening cross-sections.

In other words, the filter chambers having filter elements without deposits arranged therein preferably all have the same flow resistance. This further preferably applies to the individual filter chamber combinations consisting of filter chamber and individual supply pipes and discharge pipes to/from the filter chamber. Here, in addition to the filter chamber, a filter chamber combination comprises all further elements that are arranged together with the filter chamber parallel to other filter chamber combinations in the gas circuit. Here, the flow resistance of supply pipes and discharge pipes is determined, in particular, by the (minimum) area of the opening cross-section. An equal flow resistance can be realized, for example, in that all filter chambers, in particular all filter elements, have an equal construction, so that they contribute equally to the overall flow resistance when the filter chambers are arranged parallel to one another in the flow. In particular, the filter elements of all filter chambers can also have the same filter medium, which means that the filter elements consist of the same material (e.g. fabric filters with 20 μm polyester fibers or PE sintered filters) and/or belong to the same filter class.

In a special embodiment, the gas control device is constructed such that during the ongoing production process it ensures at least temporarily, preferably all the time, that a numerical ratio of filter chambers that are not separated from the process gas circuit to filter chambers that are separated from the process gas circuit is greater than or equal to a minimum value of 55:45, preferably 60:40, further preferably 2:1, even more preferably 70:30, even further preferably 3:1, particularly preferably 4:1.

The larger the ratio between filter chambers that are not separated from the process gas circuit to filter chambers that are separated from the process gas circuit, i.e. between filter chambers that are in the operating state of filtering the process gas to filter chambers that are not in the operating state of filtering the process gas, the smaller the fluctuation in the volume flow that is caused by the separation of a number of filter chambers. Therefore, particularly when the number of filter chambers increases, which number in principle has no upper limit, i.e. basically can even go up to a value of several hundred or up to the value 1000, a minimum value can preferably be specified for the ratio that must not be undershot. For example, when 5 filter chambers are present, a minimum value of 3:2 can be specified, when 10 filter chambers are present, a minimum value of 60:40 can be specified, or when 20 filter chambers are present, a minimum value of 55:45 can be specified.

In a special embodiment, all filter chambers arranged in the gas circuit are always arranged parallel to one another.

There is furthermore the possibility that a plurality of filter chambers is arranged in series and this arrangement in series is arranged parallel to further filter chambers or further arrangements of filter chambers in series. In an arrangement of filter chambers in series, filter elements located upstream can carry out a prefiltering of the process gas, so that filter elements located downstream can carry out a fine filtering. It is e.g. also possible in an arrangement of filter chambers in series, to configure only the filter element(s) located upstream such that they can be cleaned and/or replaced.

In a special embodiment, the at least three filter chambers are subspaces of one or more main chambers of the filter system which subspaces are delimited from one another in a gas-tight manner.

For the overall flow resistance, which is important in the context of the present invention, it does not matter whether the plurality of filter chambers is spatially separated from one another or whether the plurality of filter chambers are subregions of a single chamber, the main chamber. In the latter case it is only important that the subregions are delimited from one another in a gas-tight manner, so that the individual filter chambers can be sealed off from the gas circuit independently of one another. Likewise, in the case of a spatial separation of the filter chambers, it should be ensured that the flow resistances of the individual filter chambers are not too different from one another as a result of the supply pipes and discharge pipes of the individual filter chambers differing too much in flow resistance. Finally, it is also possible to provide a plurality of main chambers which are spatially separated from one another and have subregions therein, wherein the subregions respectively serve as filter chambers.

In a special embodiment, for each of the at least three filter chambers a switching unit is provided upstream and/or a switching unit is provided downstream, by means of which switching unit this filter chamber can respectively be sealed off from the gas circuit separately from the other filter chambers.

The gas control device is preferably designed such that it can actuate one or more switching units or valves upstream and/or one or more switching units or valves downstream of the plurality of filter chambers. As a result, for example during maintenance operations on the filter chambers, the gas control device can separate one or more filter chambers from the gas circuit, so that the process gas then only flows through the filter chambers still remaining in the gas circuit. In particular, a switching unit can be a controllable valve such as a pinch valve. The switching units can be actuated either via connecting lines or wirelessly. This can take place independently of a manufacturing process running in the additive manufacturing apparatus.

Although it is possible to seal off a plurality of filter chambers together from the gas circuit, there is more freedom if there exists the option of sealing off each filter chamber separately from the gas circuit.

In a special embodiment, for each of the at least three filter chambers a pressure sensor is respectively provided upstream and downstream, so that a differential pressure between a raw gas side and a clean gas side of a filter element in the filter chamber can be determined.

By providing pressure sensors for each of the filter chambers, it is possible to derive from the differential pressure for each filter chamber separately the amount of deposits on the filter element and to decide individually for each filter chamber whether a cleaning or a change of the filter element has to be carried out. Even if theoretically in addition to the filter element other components can influence the pressure difference determined by means of the pressure sensors, it is nevertheless the filter element which dominates the existing pressure difference to a high degree.

In a special embodiment, for determining a differential pressure between a raw gas side and a clean gas side of a plurality of filter chambers, preferably of all filter chambers, a pressure sensor is provided upstream of a forking of a supply pipe of the raw gas to the plurality of filter chambers and a pressure sensor is provided downstream of a confluence of discharge pipes of the clean gas from the plurality of filter chambers and the differential pressure is determined by a comparison of the pressure values of the two pressure sensors.

The reduced number of pressure sensors leads to a more cost-efficient device.

In an even more special configuration, the gas control device is connected via signal connections to the pressure sensors upstream and downstream of a filter chamber and is configured to initiate a cleaning of a filter element between these pressure sensors if a differential pressure received from the pressure sensors exceeds a predetermined maximum value.

By such an approach, the device can automatically ensure that a maintenance of filter elements takes place in the sense of a cleaning or a replacement thereof. A signal connection can be either a signal line or a wireless connection (for example via radio, WLAN, NFC, Bluetooth or the like) that allows a communication between the gas control device and the pressure sensors, in particular a transmission of sensor values to the gas control device. The differential pressure determined by means of the two pressure sensors upstream and downstream provides an overall information about the clogging state of the filter elements arranged between the pressure sensors. If a plurality of filter chambers is arranged between the two pressure sensors, the filter elements can be cleaned or replaced when the predetermined maximum value is exceeded in all these filter chambers taking into account the number of filter chambers remaining in the gas circuit in accordance with the invention.

In a special embodiment, a sensor for determining a volume flow of the process gas in the closed gas circuit is arranged downstream of the filter system. The sensor is connected via a signal connection to the gas control device, wherein the gas control device is configured to initiate a cleaning of a filter element if a value of the volume flow received from the sensor falls below a predetermined minimum value.

A drop in the volume flow of the process gas downstream of the filter system that is too large indicates that the filter system has a flow resistance that is too large due to the deposits on the filter elements. A too large decrease in the volume flow can lead to an insufficient removal of contaminants from the process chamber. When the volume flow sensor is connected via a signal connection to the gas control device, the device can automatically eliminate undesired fluctuations of the volume flow (and thus of the quality of the manufactured objects). Here, for initiating a cleaning or a replacement of filter elements, the sensor for determining the volume flow can be used alternatively to or else as an additional safety device in addition to pressure sensors for determining a differential pressure upstream and downstream of filter chambers. Here, it would also be conceivable to arrange the volume flow sensor not downstream of the entire filter system, but instead downstream of a filter chamber or of the confluence of the discharge pipes of a plurality of filter chambers for being used in this way alternatively or additionally to the pressure sensors upstream and downstream of the filter chambers. If, in addition to the values of the sensor for determining the volume flow, the differential pressure values at the individual filter chambers are also taken into consideration, by the combination of the information from the pressure sensors and from the sensor for the volume flow it can be decided in a quite differentiated manner which filter elements to clean or replace when.

In a special configuration, the gas circulation system has a fan.

The fan as gas conveying system may particularly be a high-pressure fan. In particular, the gas conveying system should be preferably designed such that it is able to react sufficiently quickly to changes in the flow resistance (able to keep the volume flow sufficiently constant) when the flow resistance changes abruptly, for example due to filter chambers being separated from the gas circuit or filter chambers being introduced into the gas circuit. The fan could in particular be a centrifugal fan.

An additive manufacturing apparatus according to the invention having a process chamber for manufacturing a three-dimensional object comprises an inventive device for providing a process gas atmosphere.

Such an additive manufacturing apparatus allows the manufacture of objects having improved quality.

An inventive method of providing a process gas atmosphere during a manufacturing process of a three-dimensional object in a process chamber of an additive manufacturing apparatus, wherein the object is manufactured by applying a build material layer by layer and by solidifying the build material by supplying radiation energy to solidification positions in each layer that are assigned to the cross section of the object in this layer, wherein, in the method for providing a process gas atmosphere, a process gas conveyed through the process chamber is moved by means of a gas circulation system in a closed gas circuit, wherein a filter system having a plurality of filter chambers is arranged in the closed gas circuit, is characterized in that at least three filter chambers are present, each of which has at least one filter element for filtering particles in the gas circuit, which filter element can be cleaned by a gas pressure surge, and in that during the ongoing manufacturing process a number of filter chambers is separated from the gas circuit, wherein it is ensured that a number of filter chambers remaining in the gas circuit exceeds the number of filter chambers separated from the gas circuit at least temporarily, preferably all the time.

What has been stated further above on a corresponding apparatus for providing a process gas atmosphere applies to the details and advantages of such a method of providing a process gas atmosphere.

In a special configuration, in a filter chamber arranged in the gas circuit, the differential pressure at a filter element arranged therein is determined and a cleaning is carried out at this filter element if the determined differential pressure exceeds a predetermined maximum value.

By such an approach, it is in particular possible to automatically ensure during a manufacturing process that a maintenance of filter elements in the sense of a cleaning or replacement thereof is carried out without the requirement of a user monitoring of the manufacturing process. The differential pressure determined by means of pressure sensors upstream and downstream of filter chambers provides information about the clogging state of the filter elements arranged between the pressure sensors. If exactly one filter chamber is arranged between two pressure sensors, on which the differential pressure determination is based, the clogging state can be determined in a very detailed way. If a plurality of filter chambers is arranged between two pressure sensors, on which the detection of the differential pressure is based, in all these filter chambers the filter elements can be cleaned or replaced considering in accordance with the invention the number of filter chambers remaining in the gas circuit, when the predetermined maximum value is exceeded.

In a special embodiment, the process gas is moved in the closed gas circuit with a volume flow that exceeds a value of 50 m³/h, preferably 100 m³/h, further preferably 200 m³/h and/or falls below a value of 2000 m³/h, preferably 500 m³/h, further preferably 400 m³/h.

Under the aspect of an optimal removal of contaminants from the process gas atmosphere in the process chamber, which contaminants are generated by the irradiation of the building material, it would be desirable to select a value for the volume flow density that is as high as possible. On the other hand, high values of the volume flow density lead to an increased whirling up of building material. In practice, therefore, the target value for the volume flow density will be set depending on the selected parameters during the irradiation of the building material and depending on the building material used. By means of the inventive approach, it is ensured that fluctuations of the volume flow, as a percentage, are kept within limits.

In a special embodiment, the value of a volume flow of the process gas in the closed gas circuit is detected downstream of the filter system and a cleaning of a filter element is carried out if the detected value of the volume flow falls below a predetermined minimum value.

By a direct monitoring of the volume flow of the process gas, it can be immediately detected whether the value range for the volume flow that is to be complied with for a manufacturing process of objects having a high quality has been left. In this way, a clogging state of the filter elements in filter chambers can be determined independently of a detection of the pressure difference at the filter chambers.

In a special embodiment, the filter system is connected to at least two process chambers of a number of additive manufacturing apparatuses, wherein particularly preferably at least one centrifugal separator is assigned to each process chamber, wherein a manufacturing process of a three-dimensional object is carried out in each of the at least two process chambers in a temporally overlapping manner. The build materials used in the process chambers can all be identical or also be different from one another. In particular, the filter system is fluidically connected to at least two process chambers. The term “fluidically connected” is intended to express that the connection is such that process gas can flow from the filter system to the additive manufacturing apparatuses and vice versa.

In particular, the gas circuit can be such that the stream of the filtered process gas coming from the filter system branches in order to flow through the plurality of process chambers in parallel. Before the process gas to be filtered enters the filter system, the partial flows from the individual process chambers can then be combined again in order to be supplied to the filter system together. Such an approach requires that the same process gas atmosphere is used in all process chambers. This is not a problem when the build materials in the process chambers are the same. However, even when different build materials are used in the process chambers, it is nevertheless possible to use the same process gas, e.g. a protective gas such as argon.

A cyclone separator or centrifugal separator near the process gas outlet of a process chamber or upstream of the process gas inlet of a filter system has the advantage that in this way coarse contaminants in the process gas stream can be separated out before they contaminate a pipeline system used for the gas transport or the filter system and in the worst case obstruct the same.

The process chambers can in particular belong to different additive manufacturing apparatuses for which a common (central) filter system is provided. The provision of a common filter system on the one hand reduces the costs, since not each additive manufacturing apparatus has to be equipped separately with a complex filter system. In addition, the contaminants cleaned by the filters, but also the filters covered with contaminants that have been replaced, are a material that is difficult to handle. On the one hand, depending on the build material used, self-ignition or even explosions can occur upon contact with the air. On the other hand, the contaminant residues on the filters can also pose a health hazard for the personnel involved in disposing of the same. In any case, a central handling of these hazardous materials makes it easier to dispose of them safely and with manageable risks, since complex equipment for handling the materials, e.g. a suitable protective gas atmosphere, has to be provided only at one location.

Preferably, at least three process chambers are connected to the filter system and it is ensured, in particular as long as a manufacturing process is ongoing in one of the process chambers, that a number of the process chambers through which the process gas flows exceeds a number of the process chambers through which the process gas does not flow.

In a case in which the additive manufacturing processes in the different process chambers do not exactly overlap in time, in particular do have different durations, it is usually desired to separate a process chamber in which, for example, the manufacturing process is already completed from the process gas circuit in order to be able to remove the manufactured objects. This too can lead to abrupt changes in the flow resistance that can be countered with the described approach in order not to impair the manufacturing process in the process chambers through which the process gas still flows.

A further inventive method serves for providing a process gas atmosphere during a manufacturing process of a three-dimensional object in a plurality of process chambers of a number of additive manufacturing apparatuses, in each of which at least one object is manufactured by applying a build material layer by layer and by solidifying the build material by supplying radiation energy to solidification positions in each layer that are assigned to the cross section of the object in this layer, wherein there exists a gas circulation system with a gas circuit that is closed during operation, for a process gas conveyed through the process chambers, wherein a filter system with a number, preferably with a plurality, of filter chambers is arranged in the closed gas circuit, wherein the filter system is connected to at least two process chambers, wherein particularly preferably at least one centrifugal separator is assigned to each process chamber, wherein a manufacturing process of a three-dimensional object is carried out in each of the at least two process chambers in a temporally overlapping manner, wherein at least three process chambers are connected to the filter system and it is ensured, in particular as long as a manufacturing process is ongoing in one of the process chambers, that a number of the process chambers through which the process gas flows exceeds a number of the process chambers through which the process gas does not flow.

In an inventive additive manufacturing method for manufacturing a three-dimensional object in a process chamber of an additive manufacturing apparatus, wherein the object is manufactured by means of the additive manufacturing apparatus by applying a build material layer by layer in the process chamber and by solidifying the build material by supplying radiation energy to solidification positions in each layer that are assigned to the cross section of the object in this layer, an inventive method for providing a process gas atmosphere is used during the manufacturing process.

Such an additive manufacturing method allows the manufacture of objects having improved quality.

Further features and practicalities of the invention arise from the description of exemplary embodiments with reference to the attached drawings.

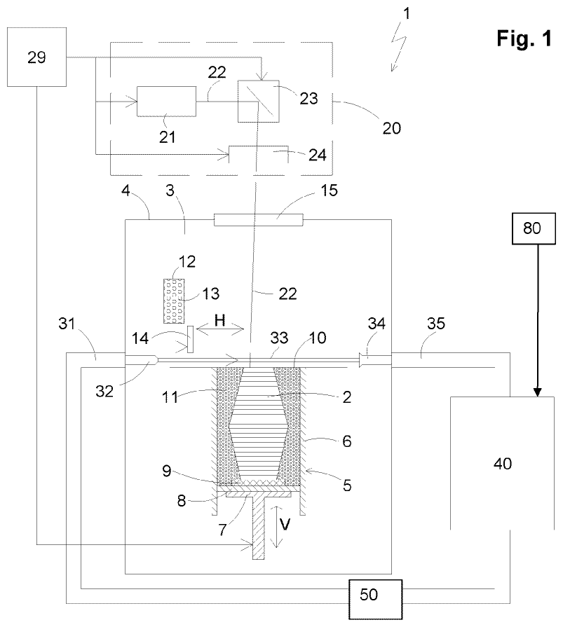

FIG. 1 shows a schematic, partially sectional view of an exemplary inventive additive manufacturing apparatus having an exemplary inventive device for providing a process gas atmosphere.

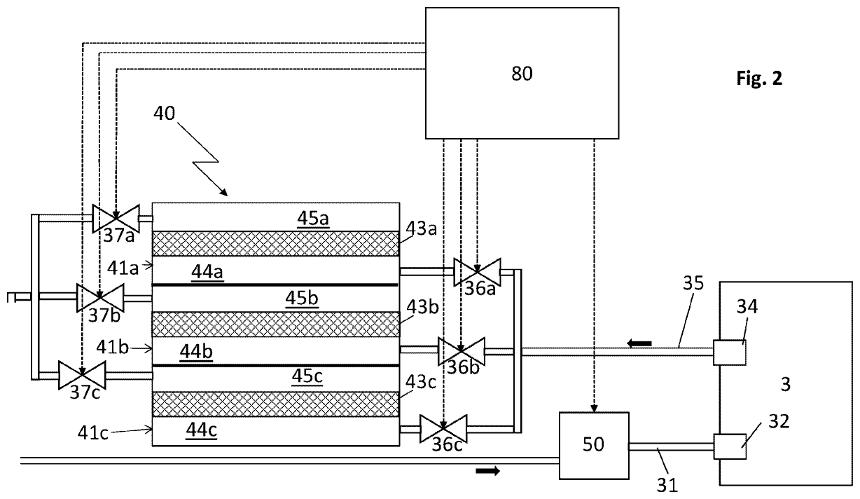

FIG. 2 shows a schematic representation of an embodiment of a device for providing a process gas atmosphere.

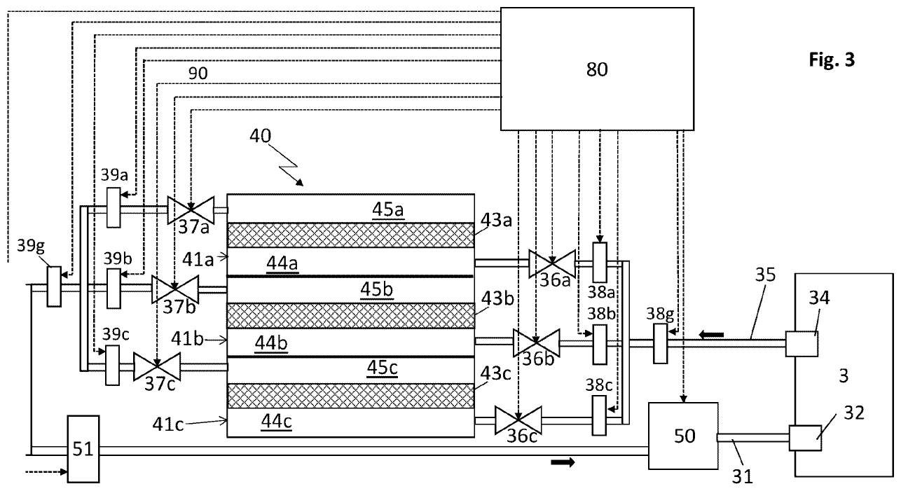

FIG. 3 shows the representation of FIG. 2, wherein an exemplary arrangement of sensors in the gas circuit is additionally shown.

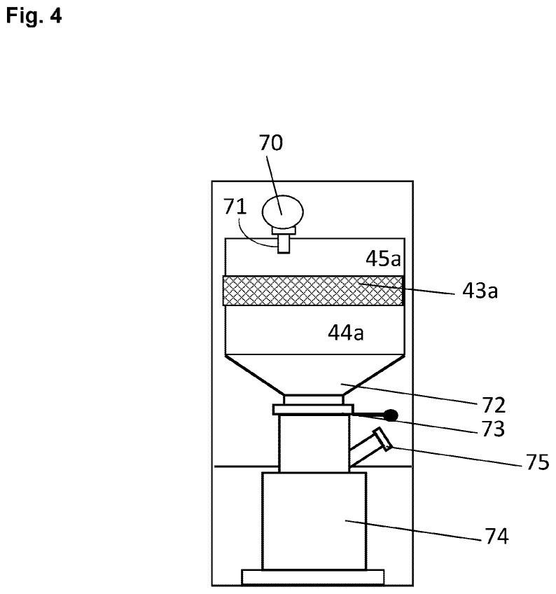

FIG. 4 illustrates an exemplary approach in the cleaning of a filter element.

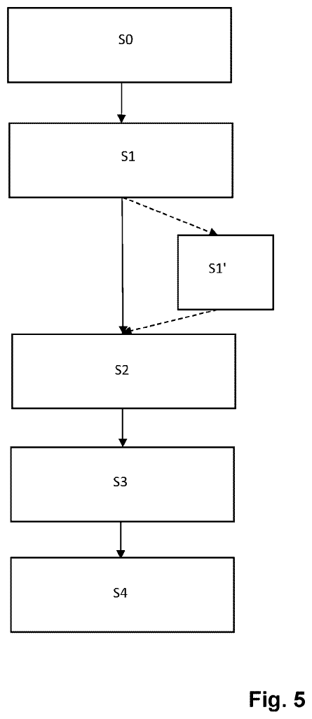

FIG. 5 illustrates an exemplary process sequence in a replacement or a cleaning of a number of filter elements.

In the following, with reference to FIG. 1, at first a basic construction of an additive manufacturing apparatus to which the present invention relates is described using the example of a laser sintering or laser melting apparatus. The laser melting apparatus 1 shown in FIG. 1 comprises a process chamber 3 having a chamber wall 4 for building up an object 2.

A container 5 open to the top, which has a container wall 6 is arranged in the process chamber 3. A working plane 10 is defined by the upper opening of the container 5, wherein the region of the working plane 10 lying within the opening, which can be used for building up the object 2, is referred to as a build field.

Arranged in the container 5 is a carrier 7 which is movable in a vertical direction V and to which a base plate 8 is attached, which closes the container 5 to the bottom and thus forms the bottom thereof. The base plate 8 can be a plate which is formed separately from the carrier 7 and which is attached to the carrier 7, or it can be formed integrally with the carrier 7. Depending on the powder and process used, a build platform 9 can also be attached to the base plate 8 as a build support, on which the object 2 is built up. However, the object 2 can also be built up directly on the base plate 8, which then serves as a build support. In FIG. 1, the object 2 to be formed in the container 5 on the build platform 9 is shown below the working plane 10 in an intermediate state with a plurality of solidified layers, surrounded by build material 11 that has remained unsolidified.

The laser melting apparatus 1 furthermore comprises a storage container 12 for a powder-like or paste-like build material 13 that can be solidified by electromagnetic radiation and a coater 14, which is movable in a horizontal direction H, for applying the build material 13 within the build field. Preferably, the coater 14 extends transversely to its direction of movement over the entire region to be coated.

On its upper side, the wall 4 of the process chamber 3 contains a coupling window 15 for the laser beam 22 serving to solidify the powder 13.

The laser melting apparatus 1 furthermore contains an exposure device 20 having a laser 21 that generates a laser beam 22, which is deflected via a deflection device 23 and focused onto the working plane 10 via the coupling window 15 by a focusing device 24.

Furthermore, the laser melting apparatus 1 has a control unit 29, by which the individual constituents of the laser melting apparatus 1 are controlled in a coordinated manner for carrying out the build process. The control unit may contain a CPU, the operation of which is controlled by a computer program (software). The computer program may be stored on a storage medium, from which it can be loaded into the apparatus, in particular into the control unit. In the present application, the term “control unit” includes any computer-based control unit that is capable of controlling or regulating the operation of an additive manufacturing apparatus, in particular of components thereof. Here, the connection between the control unit and the controlled components does not necessarily have to be cable-based, but rather can also be implemented by means of radio, WLAN, NFC, Bluetooth or the like, in that the control unit comprises corresponding receivers and transmitters.

During operation, in order to apply a layer of the build material, first the carrier 7 is lowered by an amount that corresponds to the desired layer thickness. Thereafter, the coater 14 travels over the build field and applies there a layer of build material 13 on the build support or an existing layer of already selectively solidified build material. The application takes place at least over the entire cross section of the object 2 to be manufactured, preferably over the entire build field, meaning the region delimited by the container wall 6.

Subsequently, the cross section of the object 2 to be manufactured is scanned by the laser beam 22, so that the build material 13 in powder form is solidified at the positions that correspond to the cross section of the object 2 to be manufactured. Here, the powder grains at these positions are partially or completely melted by means of the energy introduced by the radiation, so that after cooling they are connected to one another and exist in solid state. These steps are repeated until the object 2 is finished and can be removed from the process chamber 3.

As already mentioned at the outset, depending on the type of build material used, spatters, smokes, vapors and/or gases that propagate into the process chamber and impair the manufacturing process, also referred to as welding smoke, are formed during the irradiation with the laser beam, in particular during sintering or melting of metal powder. In order to avoid such impairments of the manufacturing process, a process gas flow is conveyed over the working plane 10. In order to generate a laminar gas flow 33 above the working plane 10, the laser melting apparatus 1 contains a gas supply channel 31, a gas inlet nozzle 32, a gas outlet nozzle 34 and a gas discharge channel 35. The gas supply and discharge may be controlled by a separate gas control device 80, which in FIG. 1 is shown separately from the control unit. However, a control by the control unit 29 is also possible. Via the gas discharge channel 35, the gas exiting the process chamber 3 is supplied to a filter system 40, which filters out (in particular metallic) contaminants from the process gas, and is then again supplied to the process chamber 3 via the gas supply channel 31. A gas circulation system is formed by the gas supply channel 31, the gas inlet nozzle 32, the gas outlet nozzle 34, the gas discharge channel 35 and a gas conveying device 50, e.g. a circulation fan, in particular a high-pressure fan, which gas circulation system during operation renders possible a closed gas circuit for a process gas conveyed through the process chamber.

FIG. 2 shows a schematic representation of an example of a device for providing a process gas atmosphere in the process chamber. In addition to the gas circulation system, this device also comprises the filter system 40 and the gas control device 80, which were already shown in FIG. 1 and are shown in FIG. 2 in greater detail. In the example of FIG. 2, the filter system 40 contains three filter chambers 41a, 41b and 41c, which in the figure are shown as subspaces of a main chamber that are separated from one another in a gas-tight manner but can also be chambers that are spatially separated from one another.

According to the invention, there are at least three filter chambers. In other words, also a greater number of filter chambers than shown in FIG. 2 may be present and all explanations of the inventive approach in the present application are equally applicable to the presence of four, five or more filter chambers, which can be arranged parallel to one another in the process gas circuit.

Each filter chamber 41a, 41b, 41c contains a filter element 43a, 43b and 43c, respectively. As filter elements, for example fabric filters with 20 μm polyester fibers or PE sintered filters can be used. Furthermore, a raw gas space 44a, 44b and 44c, respectively, and a clean gas space 45a, 45b and 45c, respectively, are present in each filter chamber on both sides of the filter element 43a, 43b, 43c. The gas containing the contaminants (often referred to as raw gas) can be supplied to each of the raw gas spaces 44a, 44b and 44c, respectively, via the gas discharge channel 35. From each of the clean gas spaces 45a, 45b, 45c, the filtered gas (often referred to as clean gas) is supplied via the gas supply channel 31 to the process chamber 3 again, where it enters at the gas inlet 32 arranged in the chamber wall 4.

The gas inlets of the filter chambers are preferably configured such that the supplied gas flow is not directed directly onto a filter element. For example, the gas can be guided laterally into the filter chamber onto a circular path. Thereby, a cyclone effect is utilized and larger particles, e.g., entrained constituents of the build material (e.g., metal powder) do not even reach the filter element.

Furthermore, FIG. 2 shows the gas conveying device 50, e.g., a high-pressure fan, arranged in the gas circuit, wherein the flow direction in the gas circuit is indicated by arrows. Not shown in the figure are a preferably present fine filter, which is arranged upstream of the gas conveying device 50, as well as an optional particle separator, e.g., a centrifugal separator or cyclone separator, in the gas discharge channel 35.

Over time, the filtered particles are deposited on the fabric of a filter element 43a, 43b and 43c, respectively. They are compacted by the pressure exerted by the process gas flow and can agglomerate depending on the material and the temperature. Thus, over time, a filter covering made of a layer of compacted particles and/or particles adhering to one another, which is generally referred to as “filter cake”, will form. The filter cake impedes the gas flow and leads to a steadily increasing pressure drop at the filter, i.e., to an increase of the pressure difference between the raw gas side and the clean gas side of the filter element, i.e., between the raw gas space 44a, 44b and 44c, respectively, and the clean gas space 45a, 45b and 45c, respectively. Therefore, from time to time, the filter elements 43a, 43b and 43c, respectively, must be cleaned in order to remove the filter cake or must be replaced.

An exemplary approach in the cleaning is explained with reference to FIG. 4. This figure shows schematically a cleaning device 70, which has been connected to the clean gas space 45a, 45b and 45c, respectively, of a filter element 43a, 43b and 43c, respectively (in the figure, the clean gas space 45a and the filter element 43a, by way of example).

In order to clean the filter element 43a, a gas pressure surge is generated by the cleaning device 70, which gas pressure surge is supplied to the clean gas space 45a via the cleaning nozzle 71. For example, the cleaning device 70 may contain for this purpose a pressure vessel with a pressurized protective gas, out of which individual gas pressure surges are taken as needed. A gas pressure surge has, for example, a peak pressure of 5 or 10 bar and penetrates the filter element 43a to be cleaned opposite to the normal filter direction, in which the process gas to be filtered flows through the filter element 43a. As a result, the gas pressure surge acts on the filter cake from the outlet side of the filter element 43a. As a result, the filter cake is detached from the filter element 43a in a planar manner, breaks into clumps and is pushed away from the filter element 43a by the gas pressure surge. The individual pieces of the filter cake drop downwards attracted by gravity and reach a collecting funnel 72, in the lower section of which there is a closure 73, e.g., an iris or a pneumatically/electrically actuated disk flap, with which the collecting funnel 72 can be sealed off downwards in a gas-tight manner. A collecting container 74 (sometimes also referred to as waste container) is located underneath. Optionally, a passivation nozzle 75 is provided, which can serve to fill passivation material into the collecting container 74. However, it is also possible to dispense with the introduction of passivation material. Furthermore, a protective gas nozzle (not shown in the figure) can optionally be provided for introducing a protective gas, which can be identical to a protective gas used in the process chamber, into the collecting container 74. Further details of the apparatus known to a person skilled in the art are not shown in schematic FIG. 4 for reasons of better clarity, for example, a venting used for rendering the filter chamber inert or a filling level sensor or a pressure sensor in the collecting container 74.

As shown in FIG. 2, the gas discharge channel 35 is divided into three partial channels (without reference numbers), via which the gas to be filtered is supplied to the raw gas spaces 44a, 44b, 44c of the filter chambers 41a, 41b, 41c. Likewise, the outlets of the clean gas spaces 45a, 45b, 45c are combined in order to supply the filtered gas via the gas supply channel 31 to the process chamber 3. Here, the gas supply to the raw gas spaces 44a, 44b, 44c can be interrupted individually by switching units 36a, 36b, 36c (for example, electrically or electromagnetically actuatable valves). Likewise, the gas discharge from the clean gas spaces 45a, 45b, 45c can be interrupted individually by switching units 37a, 37b, 37c (for example, electrically or electromagnetically actuatable valves). Thereby, it can be ensured that no ambient atmosphere enters the process gas atmosphere when a filter element is replaced or else that no adverse effects on the pressure in the process chamber occur when filter elements are cleaned by means of a gas pressure surge.

In FIG. 2, a gas control device 80 is shown, which is connected to the switching units 36a, 36b, 36c and to the switching units 37a, 37b, 37c by means of control lines (without reference numbers) shown in dashed lines in order to be able to actuate them. Even if control lines are explicitly shown in the figure, it is clear that the communication between the gas control device 80 and the switching units can also be wireless, for example by means of radiocommunication, WLAN, NFC, Bluetooth or the like, in that the control unit and the switching units comprise corresponding receivers and transmitters. The same applies to the optional control signal connection between the gas control device 80 and the gas conveying device 50.

In the event that one or more filter elements are to be cleaned or replaced, for example, the filter element 43a, the gas control device 80 actuates the corresponding switching units, in the example 36a and 37a, in order to disconnect the associated filter chamber 41a from the gas circuit through the process chamber 3. Here, the gas control device 80 ensures that the number of filter chambers arranged in the gas circuit exceeds the number of filter chambers not arranged in the gas circuit. For example, the control (implemented e.g. by means of software) in the gas control device is correspondingly designed. In particular, it can check whether the number of filter chambers to be disconnected from the gas circuit through the process chamber 3 is greater than or equal to the number of filter chambers remaining in the gas circuit through the process chamber 3 and, if this is the case, automatically disconnect a smaller number of filter chambers from the gas circuit. In particular, one can also proceed stepwise. This means that it is first checked whether a number of filter chambers to be disconnected that has been reduced by 1 is still greater than or equal to the number of filter chambers remaining in the gas circuit through the process chamber 3 and, if so, the number of filter chambers to be disconnected is again reduced by 1 in order to carry out a new check. Only when the check reveals that the number of filter chambers to be disconnected is smaller than the number of filter chambers remaining in the gas circuit is the current number of filter chambers to be disconnected actually disconnected from the gas circuit.

In order to determine how many filter chambers are currently arranged in the gas circuit and/or how many are disconnected, the gas control device can check the switching state of the switching units 36a, 36b, 36c, 37a, 37b and 37c, respectively. Regardless of this, a value Nₘₐₓ of the maximum permissible number of filter chambers, which may be disconnected from the gas circuit at the same time, may be stored in a memory, e.g. in the gas control device. The gas control device then compares e.g. the number of filter chambers currently disconnected from the gas circuit with the value Nₘₐₓ and sets e.g. a blocking flag if the value Nₘₐₓ would be exceeded by the disconnection of a further filter chamber. The value Nₘₐₓ of the maximum permissible number of filter chambers, which may be disconnected from the gas circuit at the same time, can be predetermined depending on the total number Nₜₒₜₐₗ of filter chambers connectable to the process chamber. Optionally, this value can be input by a user of the additive manufacturing apparatus before the start of a manufacturing process, in particular after a change of the number of filter chambers available for a filtering of the process gas flow.

In an alternative approach, if filter elements are to be cleaned or replaced, the maximum permissible number of filter chambers Nₘₐₓ is always separated from the gas circuit. Also in this way, it is ensured that the number of filter chambers arranged in the gas circuit always exceeds the number of filter chambers not arranged in the gas circuit.

There is no need to say that one can proceed in the same manner if it is ensured that a numerical ratio (e.g.: 2:1) of filter chambers not separated from the process gas circuit to filter chambers separated from the process gas circuit is not undershot. In such a case, the value of the variable Nₘₐₓ can be correspondingly adapted.

Optionally, the gas control device 80 may output a warning signal each time the number of filter chambers to be disconnected from the gas circuit through the process chamber 3 is greater than or equal to the number of filter chambers remaining in the gas circuit through the process chamber 3 or a numerical ratio of filter chambers not separated from the process gas circuit to filter chambers separated from the process gas circuit is undershot. The warning signal can be an acoustic signal and/or an optical signal.

If three filter chambers are present, this means that it is ensured that at least two filter chambers are always arranged in the process gas circuit during the manufacturing process. If four or five filter chambers are present, this means that it is ensured that at least three filter chambers are always arranged in the process gas circuit during the manufacturing process. If six or seven filter chambers are present, this means that it is ensured that at least four filter chambers are always arranged in the process gas circuit during the manufacturing process.

The determination of when a filter element should be replaced or cleaned can be effected by means of sensors arranged upstream and downstream of a filter chamber in the gas circuit. This is explained with reference to FIG. 3.

FIG. 3 is very similar to FIG. 2. The difference to FIG. 2 is that sensors 38a, 38b, 38c, 38g, 39a, 39b, 39c and 39g are additionally shown in FIG. 3, which sensors have been omitted in FIG. 2 for reasons of clarity. The sensors 38a, 38b, 38c, 38g, 39a, 39b, 39c and 39g are pressure sensors. By comparing the values detected by sensors 38a and 39a, 38b and 39b and 38c and 39c, respectively, the pressure difference at the associated filter chamber 41a, 41b and 41c, respectively, can be determined. If the pressure difference at a filter chamber exceeds a predetermined maximum value, this can be used as an indicator that the filter element in the corresponding filter chamber should be replaced or cleaned.

Although the two sensors 38g and 39g are shown in addition to the sensors 38a, 38b, 38c, 39a, 39b and 39c, they can also be arranged in the gas circuit instead of the sensors 38a, 38b, 38c, 39a, 39b and 39c. By comparing the values detected by the sensors 38g and 39g, the pressure difference at the entirety of filter chambers arranged parallel to one another in the gas circuit can be determined and it can be decided on the basis of this pressure difference whether a replacement or a cleaning of any of the filter elements has to take place or not. It should be noted that alternatively or additionally, the pressure difference for only a subset of the entirety of filter chambers arranged parallel to one another in the gas circuit can be determined by means of two sensors upstream and downstream of this subset in the gas circuit.

In FIG. 3, for reasons of clarity, reference number 90 globally denotes signal lines (dashed lines) between the sensors and the gas control device 80, via which the pressure values determined by the respective sensors can be transmitted to the gas control device 80, and signal lines between the gas control device 80 and the switching units. The gas control device 80 can determine pressure differences at the filter chambers on the basis of the pressure values transmitted by the sensors and can automatically decide when a replacement or a cleaning of filter elements is necessary. Even if signal lines are explicitly shown in the figure, it is clear that the communication can also be wireless, for example by means of radio, WLAN, NFC, Bluetooth or the like, in that the gas control device and the switching units comprise corresponding receivers and transmitters.

Finally, FIG. 3 also shows a sensor 51 for determining the volume flow in the gas circuit, which is also connected to the gas control device 80 via a signal connection. In FIG. 3, the sensor 51 is shown upstream of the gas conveying device 50, but it can alternatively also be arranged downstream. If the sensor 51 indicates a drop of the volume flow below a predetermined minimum value, it can be decided independently of the differential pressure values determined by means of the pressure sensors that a cleaning or a replacement of filter elements is to take place. If, however, the differential pressure values at the individual filter chambers are additionally taken into consideration for the decision, by the combination of the information from the pressure sensors and from the sensor for the volume flow it can be decided in a quite differentiated manner which filter elements to clean or replace when.

In the following, with reference to FIG. 5, a possible process sequence in a replacement or a cleaning of a number of filter elements by means of a correspondingly adapted gas control device 80 is described. Here, the starting point of the process sequence (step S0) is a point in time at which it was decided that in a plurality i of filter chambers a filter element has to be replaced or cleaned. This decision can, for example, have been made automatically by the gas control device 80 on the basis of the pressure differences at the individual filter chambers.

In step S1, following the decision, it is determined whether the number Nᵢ of filter chambers, in which a filter element has to be replaced or cleaned, is greater than or equal to half of the total number Nₜₒₜₐₗ of filter chambers, which are connectable to the additive manufacturing apparatus during a manufacturing process. If this is the case, a step S1′ is carried out in which it is checked whether a number Nᵢ₋₁ of filter chambers would also be greater than or equal to half of the total number of filter chambers. If this is not the case, the process step S2 is carried out next. If a number Nᵢ₋₁ of filter chambers is also greater than or equal to half of the total number of filter chambers, it is successively checked whether a number Nᵢ₋₂, Nᵢ₋₃, etc. of filter chambers is greater than or equal to half of the total number of filter chambers until this is no longer the case for a number Nᵢ₋ⱼ(j>1) and the process can then proceed to step S2.

In step S2, the gas control device 80 actuates the switching units downstream and upstream of those i filter chambers, in which the filter element is to be cleaned or replaced, in order to separate these filter chambers from the gas flow. If the process step S1′ was carried out, not Nᵢ but Nᵢ₋₁ and Nᵢ₋ⱼ filter chambers are separated accordingly.

In step S3, a cleaning process of the filter elements in the separated filter chambers then takes place in a known manner or a replacement of the filter elements in these filter chambers takes place. At the end of the cleaning process or replacement process, a termination signal is transmitted to the gas control device 80. In a cleaning process, this takes place automatically; in a replacement process, this can likewise be the case, however, can also be effected manually. After receiving the termination signal, which indicates that a filter chamber is ready for operation again, in step S4 the gas control device 80 opens again the switching units downstream and upstream of this filter chamber, so that the process gas again flows through the filter chamber.

It should be noted that the filter chambers to be separated from the gas circuit need not necessarily be separated from the gas circuit simultaneously, but rather also successively. This applies in particular in a case in which the pressure differences of the individual filter chambers are not determined separately by means of sensors upstream and downstream of each filter chamber, but rather the resulting pressure difference at a plurality of filter chambers arranged parallel to one another in the gas flow is determined, for example by means of the sensors 38g and 39g in FIG. 3.

Furthermore, the process sequence described with reference to FIG. 5 can be carried out in the same manner if, instead of checking whether the number Nᵢ of filter chambers, in which a filter element has to be replaced or cleaned, is greater than or equal to half of the total number Nₜₒₜₐₗ of filter chambers, it is checked whether the numerical ratio of the difference between the total number Nₜₒₜₐₗ of filter chambers and the number Nᵢ to the number Nᵢ, in other words (Nₜₒₜₐₗ−Nᵢ)/Nᵢ, falls below a predetermined minimum value or not.

In conclusion, it should be noted once again that the devices described in detail above are merely exemplary embodiments which can be modified by a person skilled in the art in a wide variety of ways, without leaving the scope of the invention. For example, a solidification may be effected with other energy beams instead of laser light. Furthermore, the use of the indefinite article “a” or “an” does not exclude that the relevant features may also be present multiple times. Likewise, the term “unit” does not exclude that it consists of a plurality of interacting subcomponents which can optionally also be spatially distributed. The expression “a number” is to be understood as “at least one”.

1. A device for providing a process gas atmosphere during a manufacturing process of a three-dimensional object in a process chamber of an additive manufacturing apparatus, wherein the object is manufactured by applying a build material layer by layer and by solidifying the build material by supplying radiation energy to solidification positions in each layer that are assigned to the cross section of the object in this layer,
wherein the device for providing a process gas atmosphere comprises a gas circulation system having a gas circuit that is closed during operation for a process gas conveyed through the process chamber, wherein a filter system having a plurality of filter chambers is arranged in the closed gas circuit,
characterized in that at least three filter chambers are present, each of which has at least one filter element for filtering particles in the gas circuit, and
in that there exists a gas control device for controlling the gas circuit, which gas control device is configured such that it can separate a number of filter chambers from the gas circuit during the ongoing manufacturing process and can ensure that a number of filter chambers remaining in the gas circuit at least temporarily exceeds the number of filter chambers separated from the gas circuit.

2. The device according to claim 1, wherein each of the filter chambers has at least one filter element for filtering particles in the gas circuit, which filter element can be cleaned by a gas pressure surge and/or can be replaced.

3. The device according to claim 1, wherein the plurality of filter chambers have substantially equal volumes and/or the filter elements have substantially equal filter areas and/or an equal filter medium and/or
supply pipes and discharge pipes respectively connected to the plurality of filter chambers have substantially equal areas of the opening cross-sections.

4. The device according to claim 1, wherein the gas control device is configured such that during the ongoing manufacturing process it ensures at least temporarily that a numerical ratio of filter chambers not separated from the process gas circuit to filter chambers separated from the process gas circuit is greater than or equal to a minimum value of 4:1.

5. The device according to claim 1, wherein all filter chambers arranged in the gas circuit are always arranged parallel to one another.

6. The device according to claim 1, wherein the at least three filter chambers are subspaces of one or more main chambers of the filter system which subspaces are delimited from one another in a gas-tight manner.

7. The device according to claim 1, wherein for each of the at least three filter chambers a switching unit is provided upstream and/or a switching unit is provided downstream, by means of which switching unit this filter chamber can respectively be sealed off from the gas circuit separately from the other filter chambers.

8. The device according to claim 1, wherein for each of the at least three filter chambers a pressure sensor is respectively provided upstream and downstream, so that a differential pressure between a raw gas side and a clean gas side of a filter element in the filter chamber can be determined.

9. The device according to claim 1 , wherein for determining a differential pressure between a raw gas side and a clean gas side of a plurality of filter chambers, a pressure sensor is provided upstream of a forking of a supply pipe of the raw gas to the plurality of filter chambers and a pressure sensor is provided downstream of a confluence of discharge pipes of the clean gas from the plurality of filter chambers and the differential pressure is determined by a comparison of the pressure values of the two pressure sensors.

10. The device according to claim 8, wherein the gas control device is connected via signal connections to the pressure sensors upstream and downstream of a filter chamber and is configured to initiate a cleaning of a filter element between these pressure sensors if a differential pressure received from the pressure sensors exceeds a predetermined maximum value.

11. The device according to claim 1, wherein a sensor for determining a volume flow of the process gas in the closed gas circuit is arranged downstream of the filter system, the sensor being connected via a signal connection to the gas control device, wherein the gas control device is configured to initiate a cleaning of a filter element if a value of the volume flow received from the sensor falls below a predetermined minimum value.

12. The device according to claim 1, wherein the gas circulation system has a fan.

13. An additive manufacturing apparatus comprising:
a process chamber for manufacturing a three-dimensional object,
wherein the additive manufacturing apparatus comprises an apparatus according to claim 1.

14. A method of providing a process gas atmosphere during a manufacturing process of a three-dimensional object in a process chamber of an additive manufacturing apparatus, wherein the object is manufactured by applying a build material layer by layer and by solidifying the build material by supplying radiation energy to solidification positions in each layer that are assigned to the cross section of the object in this layer,
wherein, in the method for providing a process gas atmosphere, a process gas conveyed through the process chamber is moved by means of a gas circulation system in a closed gas circuit, wherein a filter system having a plurality of filter chambers is arranged in the closed gas circuit,
characterized in that at least three filter chambers are present, each of which has at least one filter element for filtering particles in the gas circuit, which filter element can be cleaned by a gas pressure surge, and
in that during the ongoing manufacturing process a number of filter chambers is separated from the gas circuit, wherein it is ensured that a number of filter chambers remaining in the gas circuit at least temporarily exceeds the number of filter chambers separated from the gas circuit.

15. The method according to claim 14, wherein in a filter chamber arranged in the gas circuit, the differential pressure at a filter element arranged therein is determined and a cleaning is carried out at this filter element if the determined differential pressure exceeds a predetermined maximum value.

16. The method according to claim 14, wherein the process gas is moved in the closed gas circuit with a volume flow that exceeds a value of 400 m³ /h.

17. The method according to claim 14, wherein the value of a volume flow of the process gas in the closed gas circuit is determined downstream of the filter system and a cleaning of a filter element is carried out if the determined value of the volume flow falls below a predetermined minimum value.

18. The method according to claim 14,
wherein the filter system is connected to at least two process chambers of a number of additive manufacturing apparatuses,
wherein at least one centrifugal separator is assigned to each process chamber,
wherein a manufacturing process of a three-dimensional object is carried out in each of the at least two process chambers in a temporally overlapping manner.

19. The method according to claim 18, wherein at least three process chambers are connected to the filter system and, as long as a manufacturing process is ongoing in one of the process chambers, it is ensured that a number of the process chambers through which the process gas flows exceeds a number of the process chambers through which the process gas does not flow.

20. An additive manufacturing method for manufacturing a three-dimensional object in a process chamber of an additive manufacturing apparatus,
wherein the object is manufactured by means of the additive manufacturing apparatus by applying a build material layer by layer in the process chamber and by solidifying the build material by supplying radiation energy to solidification positions in each layer that are assigned to the cross section of the object in this layer,
wherein a method according to claim 14 is used during the manufacturing process.
